(19) United States
(12) Patent Application Publication
(10) Pub. No.: US 2015/0343649 A1
(43) Pub. Date: Dec. 3, 2015

(54) TENTACLE MECHANISM

(71) Applicant: Richard Galinson, Toluca Lake, CA (US)

(72) Inventor: Richard Galinson, Toluca Lake, CA (US)

(21) Appl. No.: 14/288,659

(22) Filed: May 28, 2014

(51) Int. Cl. B25J 18/06; B25J 9/10

(52) U.S. Cl. CPC B25J 18/06; B25J 9/104; Y10S 901/02; Y10S 901/21; Y10S 901/27

(57) ABSTRACT

A tentacle mechanism comprising an elongate helicoid stage of windings having multiple through bores formed therethrough which carry control lines for controlling the shape of stages of the helicoid tentacle. An actuator and motor control the control lines and additional cables positioned in other sets of through bores can change the length and shape of the tentacle as well as desired spatial attitude. Embodiments of the tentacle carry end effectors at the distal end-effector actuation cables couple the end-effectors to actuator and motor.

### BACKGROUND OF THE INVENTION

1. Field of the Invention

The invention relates to a flexible tentacle mechanism, in some aspects a robot arm, the tentacle mechanism having one or more controllable stages which comprise flexible helicoid windings, and manipulable through control positioning wires positioned in thru channels borne in the periphery of the windings.

2. Description of the Related Art

The flexibility and dexterity of robotic tentacles is a paradigm sought by new designs for actuators and robots. In particular, the field of robotics actively pursues robotic arms having nonrigid structures which exhibit a large number of degrees of freedom, the ability to bend in all directions, high dexterity and capability for fine manipulation.

For example, the octopus arm is a non-rigid structure that has a very large number of degrees of freedom (DOFs), the ability to bend in all directions, high dexterity, and extraordinary capability for fine manipulation.

In robotics, researchers have developed a variety of trunk-like manipulators using rigid structures and electric motors with cable tendons for actuation. These hard robotic structures—structures based on multiple flexible joints connected by stiff links—are often heavy and their control is complicated and expensive. Moreover, their underlying structures make it difficult to manipulate objects with parts of their arms other than their specialized end effectors.

“Soft” robots—robots composed of flexible components that provide multiple degrees of freedom—have many useful capabilities, including the abilities to deform their shape, to manipulate delicate objects, to conform to their surroundings, and to move in cluttered and/or unstructured environments. The flexibility of soft actuators offers potentially useful approaches to problems in robotics, and to the design of actuators, grippers, and other soft machines.

There are many demonstrations of hard robots that show highly flexible motion; these include multi-jointed trunk-like structures. By combining cable-tendon actuators with a bendable backbone made of alternating rigid and soft disks, Buckingham and Graham built trunk-like robots called “snake-arm robots” (OC Robotics, UK), which have been commercialized. It is, thus, possible to achieve some of the capabilities of soft structures even when the underlying actuating materials are hard. It is, however, difficult for hard robots to operate in certain types of unstructured and congested environments, because their underlying skeletons are rigid.

It would be desirable to improve the motion capabilities of these systems, and specifically to fabricate entirely soft robotic actuators with three-dimensional motion, low cost, and simplicity of control.

### SUMMARY OF THE INVENTION

The invention is a tentacle mechanism which comprises a helicoid longitudinal segment having a longitudinal axis. At least one control path passageway (CPP) (through-bore wire guide is formed in each segment. In the CPPs are control lines for controlling the shape of the tentacle mechanism. The control lines extend from a proximal portion of said arm to the distal portion of said arm.

Embodiments of the tentacle mechanism comprise an actuator functionally connected to the control lines. In a further embodiment, the actuator is functionally connected with a controller for controlling the actuator to cause different lengths of the tentacle mechanism to assume different or related shapes to define the desired spatial attitude of the mechanism.

The tentacle mechanism in certain embodiments comprises an end effector coupled to the distal portion of the mechanism and at least one end effector actuation cable coupled to the end effector. The cables, which control the end effector, extend from the end effector through a control passageway (CP) to the proximal portion of the tentacle mechanism. Various embodiments the tentacle mechanism comprises multiple control path passageways extending from the proximal portion of the tentacle mechanism to the distal portion of said mechanism.

### BRIEF DESCRIPTION OF THE DRAWINGS

The present invention may be readily described by reference to the accompanying drawings in which:

FIG. 1 Depiction of Central Cavity for Flexible Shaft and Control Path Passageways.

FIG. 2 Depiction of Control Path Passageways and Conduit Passageways.

FIG. 3 Cut-away view detailing Flexible Shaft containment.

FIG. 4 Cross-section of Helicoid detailing various internal passageways.

FIG. 5 Depiction of a single stage Tentacle flexing via differential pull on opposing control lines.

FIG. 6 Depiction of one embodiment of a Multi-stage Tentacle with End Effector.

FIG. 7 Depiction of a single stage Tentacle flexing in one plane.

FIG. 8a Depiction of a single stage Tentacle at rest. Opposing Control Lines at equal tension.

FIG. 8b Depiction of a single stage Tentacle Flexing via differential pull on opposing control lines

FIG. 9 Depiction of an embodiment of a Multi-Stage Tentacle Arm

FIG. 10 Depiction of a section of the robotic tentacle showing multiple turns of the helicoids spiral with CPs and CPPs running therethrough.

FIG. 11 A cut-away view of a proximal and distal portion of a tentacle and the related control line, control line housing and actuator arrangement.

### DESCRIPTION OF THE PREFERRED EMBODIMENTS

The robotic arm 5 of the invention is a flexible appendage for use as a robot arm.

The robotic arm is a single spiral 10 made of flexible material, which can bend in all direction and has high dexterity. The robotic arm moves in three dimensions upon actuation as described below.

The robotic arm is able to grip complex shapes and manipulate delicate objects. Embedding functional components into these devices (for example, a needle for delivering fluid, a video camera, or a suction cup) extends their capabilities.

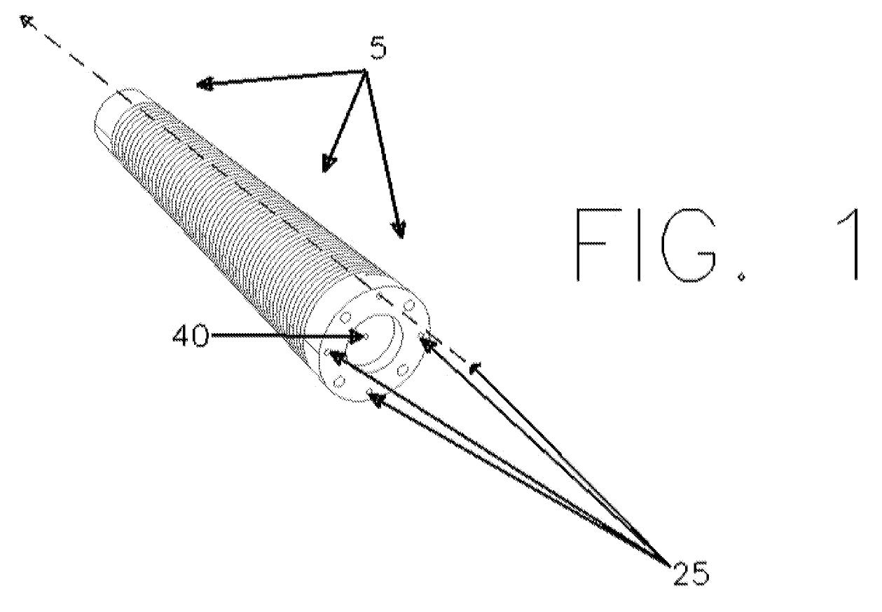

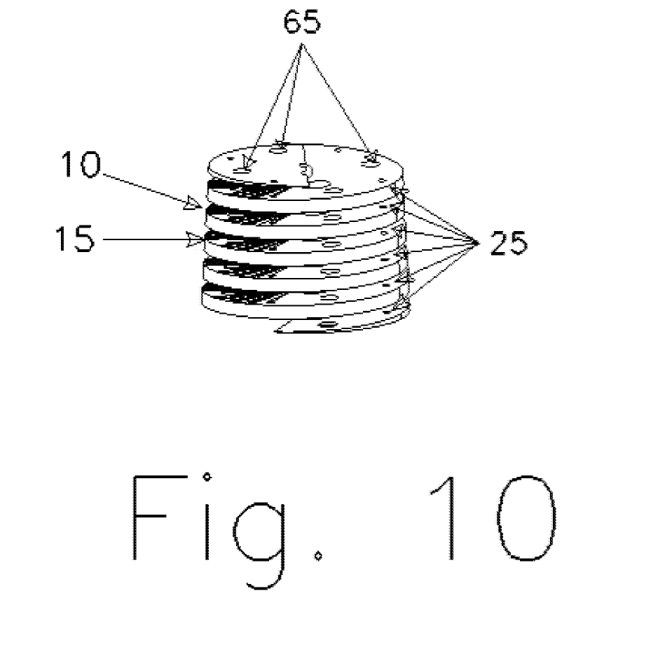

The robotic arm is defined by a helicoid 15 (FIGS. 1, 10) wound with turns. The pitch of the helicoid turns as well as the thickness of each winding are all variable.

Control path passageways pathways (CPP) 25, in one embodiment, comprise control lines 30 distributed around the axis. In any respect, it should be understood that, lines, wires or even flat, tendon-like strips, either housed or un-housed, pull the tentacle, and are referred to herein collectively as control lines.

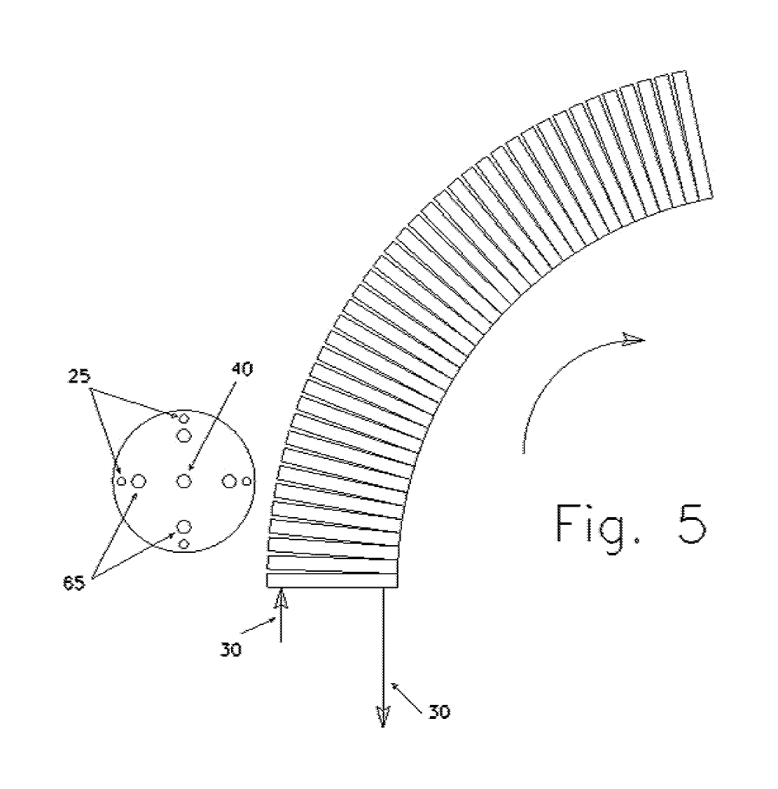

The control lines 30 in various embodiments are wires or the like having sufficient tensile strength. As shown in FIGS. 5, 7 and 8, by pulling one or more of the control lines 30 projecting outside the base tentacle, the robot arm can be bent in all directions. If a bending movement of the arm is desired, opposed control lines 30 are both subjected to differential pull, whereby the bending movement can be more or less displaced by altering the magnitudes of the pulls.

Control lines 30 pass through circumferentially-spaced, axially-aligned control path passageways CPPs 25 (through bore wire guides) formed in the circumference of the helicoid spiral. The CPPs are disposed circumferentially in the turns of the helicoids. Thus, the robotic arm or tentacle comprises hollow passageways running axially thru the length of the structure. As explained herein, one set of passageways is referred to as control path passageway (CPP) configured to allow the free movement of control lines which run therethrough.

In FIG. 1, it is shown that there are four CPPs resembling through-bore wire guides each comprising axially aligned holes, through which pass control lines 30. In certain embodiments, such as the ones illustrated, a central shaftway 40 carries a laterally flexible but rotationally stiff spine 45.

The control lines 30 extend through the length of the tentacle via the CPPs. At the distal end of the tentacle, the control lines 30 are terminated and anchored inside the distal section, or end cap of the tentacle. At the proximal end of the tentacle, each control cable extends to attach to an actuator which connects with a controller. Movement, flexing or bending of the tentacle is controlled by operating the actuators with the controller.

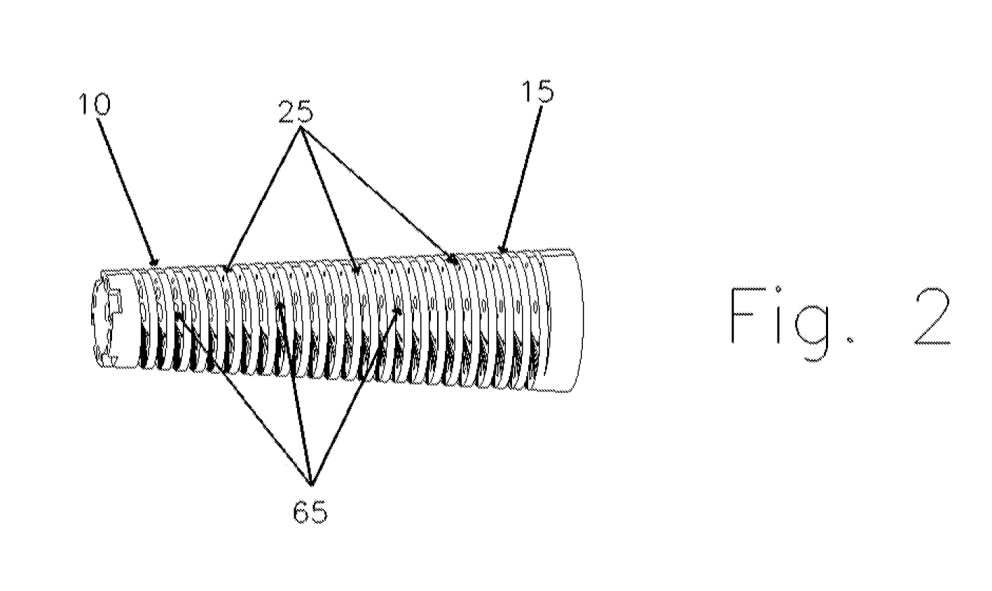

In addition to the CPPs, the device may comprise a plurality of passageways running axially, referred to herein as conduit passageways (CP). A CP may be formed so that it runs through part, or the entire device, as in FIG. 2. In those embodiments of the robotic arm which comprise an end effector 70, CPs carry communication, power, mechanical, fiber-optic, or any other signal carrying lines or combinations thereof.

Accordingly, a stage of the tentacle device requires control lines 30 to pull the respective stage tentacle in a pre-determined direction. In one non-limiting embodiment, there are 4 control lines per stage. They are used in pairs: each two control lines 30 oppose each other and effect movement of the tentacle in a “Pull-Pull” fashion. A tentacle can have a plurality of control lines 30 paired in pull-pull relationship to control the movement of a tentacle stage.

CPPs 25 may be situated on the periphery of a helicoid, or more proximal positioned, or a combination of positions according to which movements of the tentacle are desired to be achieved vis-a-vis the pull-pull functioning of the control lines 30. Peripheral positioning of the CPPs lends a finer control of the tentacle movement.

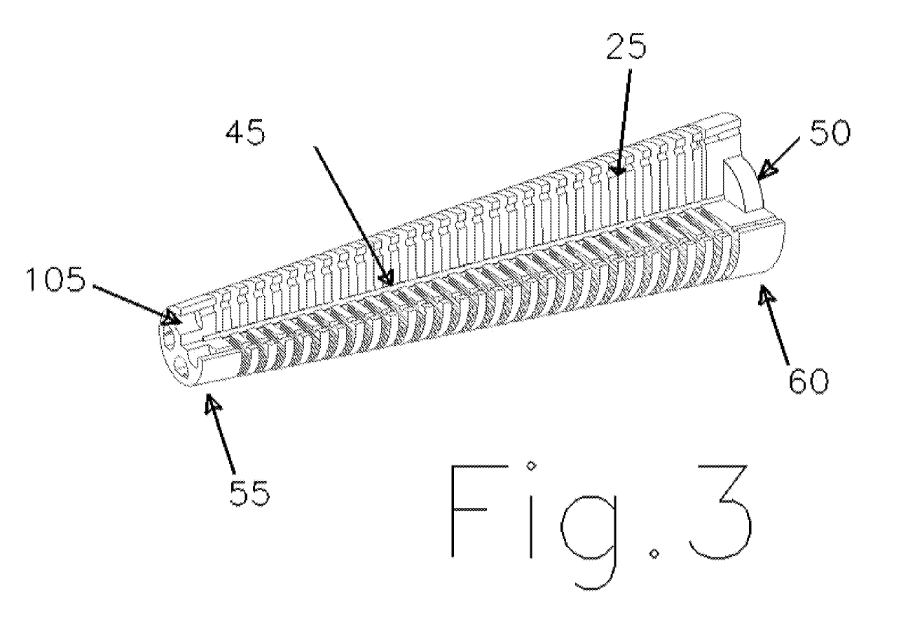

In certain embodiments, the tentacle comprises a central ‘stiffening’ shaft, or spine 45 which is positioned in a central shaftway 40, a concentrically located axial passageway. The stiffening shaft 45 is fixed in position, i.e. captured in a central shaftway 40, terminated by each end of a stage as seen in FIG. 3. Multistage embodiments of the robotic arm are described below.

In operation, the spine 45 mitigates the compression of the turns of the helicoids against each other, particularly in operations in which the tentacle bears the weight of an object; or under the typical compressive load of the control lines 30 being adjusted taught.

The degree of mitigation depends on the non-compressive nature of the material and characteristics of the spine. In a non-limiting embodiment, the spine 45 can be made from ‘Flex-Shaft’®. Flex-Shaft is often used as speedometer cable in automobiles, allowing transmission of rotation along its length without loss of that rotation from one end to the other while it bends and flexes, even severely. In a typical use of the robotic tentacle, two pairs of opposing control lines 30 remain taught while manipulating the mechanism.

Even without the spine (flex-shaft) 45 installed and under a typical differential load on a pair of control lines 30, the tentacle flexes and compresses. This compression creates shorter CPPs for the other pair of control lines 30. The shorter CPP length has the detrimental effect of slackening the other pair of control lines 30, reducing controllability. The non-compressible central spine combats this compressive force while still allowing lateral flex in all directions. This is helpful when greater precision is required in controlling movement of the tentacle when weight bearing or precision is a factor.

The cross-sectional shape of the robotic arm (e.g. circular, rectilinear, oblong, and combinations thereof) and the location of control path passageways depend on the design and tentacle application criteria chosen by the designer. For example, in theatrical and special effects arts, the shape of the tentacle can be fashioned to resemble an organic animal tongue, an octopus' tentacle or an elephant's trunk. In certain theatrical contexts where visual entertainment is key, and in which precision of movement may not be necessary, the device does not comprise a spine 45. The result of a spineless embodiment of the present invention is a tentacle with enhanced flexibility, requiring much less force to bend it in much tighter turns.

### General Structure

An elongate helicoid body member 5 defines a longitudinal axis and has oppositely disposed first and second body ends (e.g. distal 55 and proximal 60 ends) separated by a length which comprises continuous helicoid winding.

A power source is operative to selectively provide motive power to the apparatus by control lines.

The helicoid body is made of a material with flexible properties and has a plurality of actuatable helicoids winds longitudinally spaced and actuated by control lines associated therewith.

### Cabling; Control Lines 30

Aligned holes formed in the helicoids define CPPs, in which are disposed control lines. The CPPs are spaced circumferentially from the axis. Each control line can be pulled from the proximal end. The control lines shorten a lateral side of the appendage to controllably bend it.

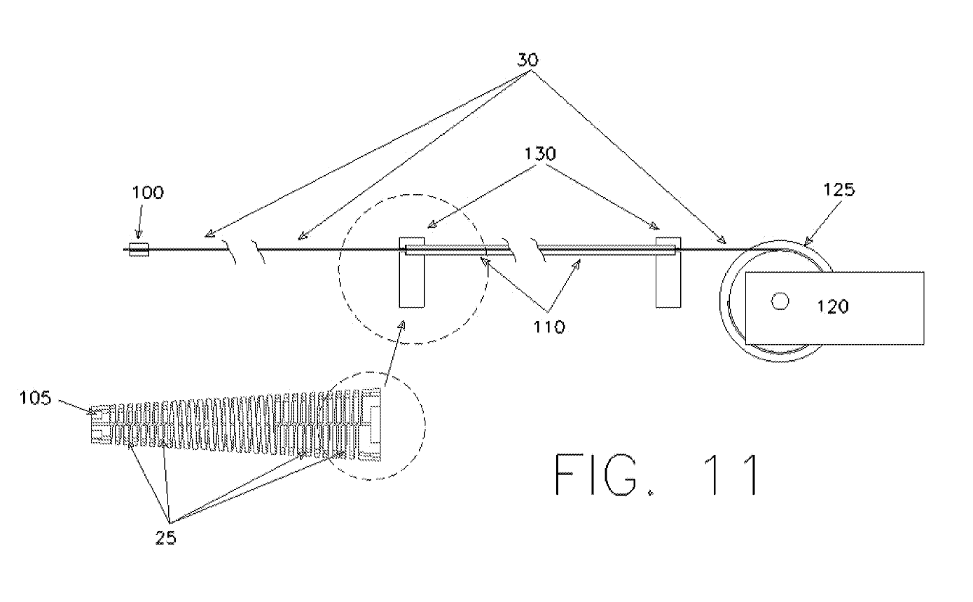

The tentacle of the present invention is supplied energy vis a vis control lines. A control line is typically housed in a ‘spring housing’ 110 or conduit. The proximal end of that housing is mounted as to be static relative to the control line being drawn out from the housing by an external motive force, such as, but not limited to an electric motor 120 or the like. Between the electric motor and the proximal end of the control line is, for example, a pulley 125. In certain embodiments, the housing of a control line is positioned in a termination cavity 130 on both of its ends, one end in the proximal region of the tentacle, the other positioned in close proximity to the actuator (for example, a pulley) as seen in FIG. 11.

A control line runs all the way through the control line housing to the actuated device where the distal end of the housing is, again, securely mounted or anchored into the proximal end of the tentacle.

A control line continues out of its housing and into the robotic arm, wherein the control line passes through the entire tentacle mechanism by traversing through a set or sets of CPPs (through bore holes) in each of the helical spirals until reaching the distal end of that stage.

The control lines terminate and are secured to the distal end of the device such that the terminated end of a control line and a CPP co-terminate in the distal end of the device in a cavity 105. In other embodiments, the control line is crimped or anchored outside the helicoids, either on the outer surface or external to that. For example, a small sleeve 100 is forcefully crimped onto the end of a control line; the end of the control line is tied into a sizable knot; super glue may be added to form a ball and secure the knot. Alternatively, a clamp is used to hold a control line cable in place.

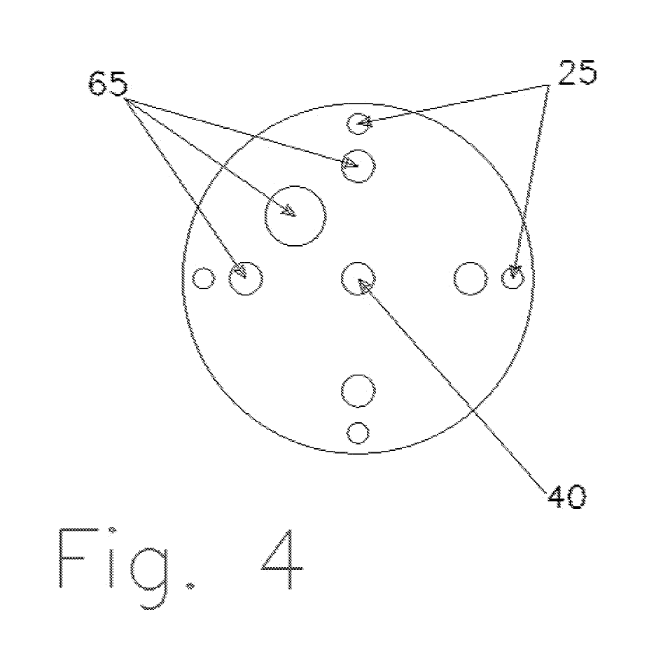

FIG. 4 shows a cross-section of a helicoid in which are disposed a central shaftway 40, CPPs 25 and CPs 65.

### Actuation

At the beginning of the actuation, the bending concentrates throughout the arm. Once the tentacle robotic arm encounters sufficient resistance, the center of the bending motion then propagates away from the resistance, bending the arm in a circular pattern.

FIG. 5 shows the curling motion of the tentacle upon one control line 30 being pulled and its opposing control line 30 being released.

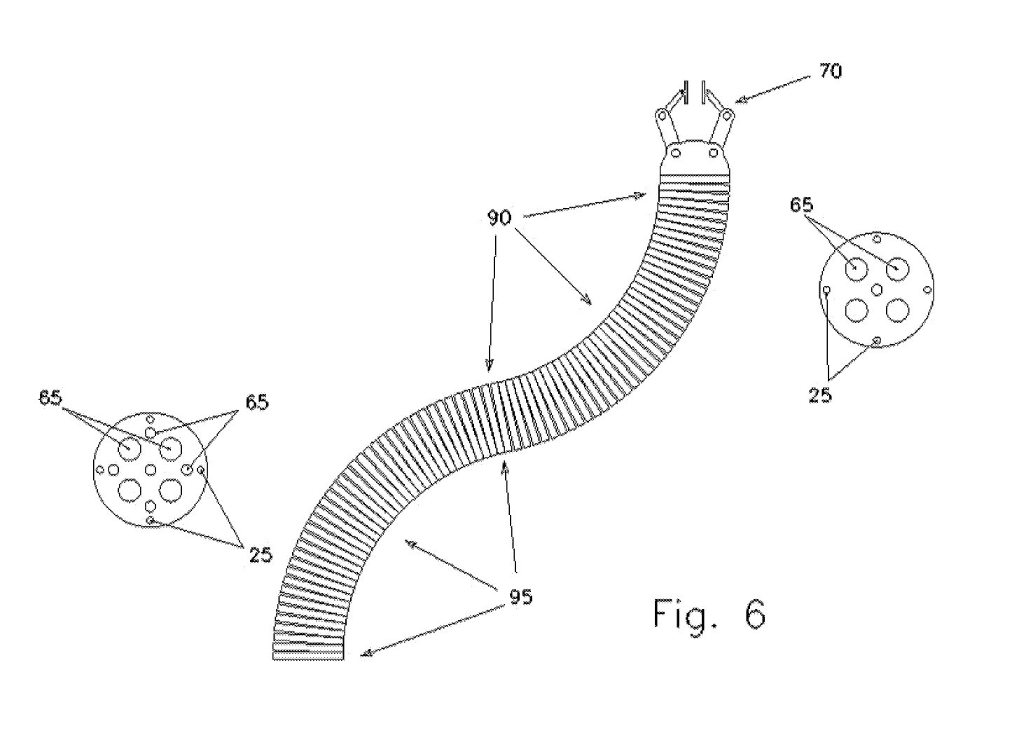

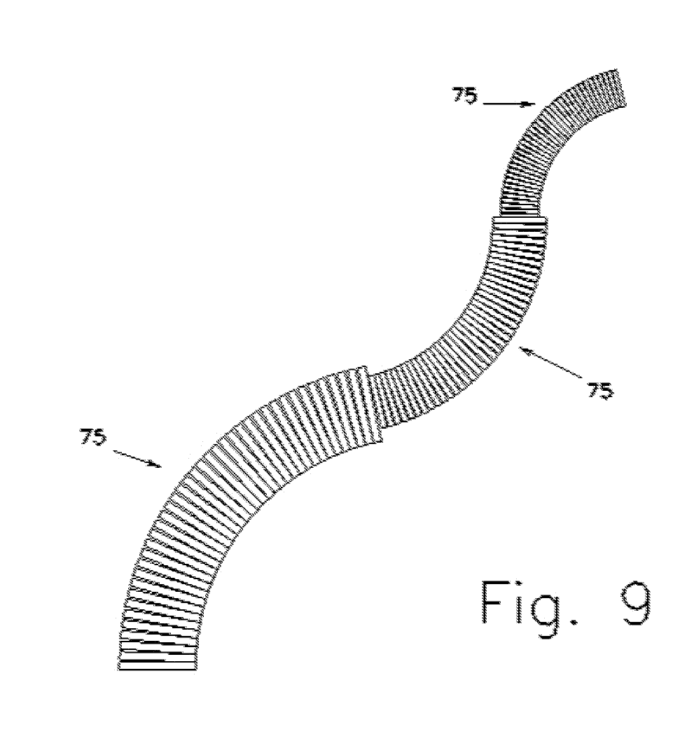

Robotic arms with multiple helicoids stages FIGS. 6 and 9 can adopt complex shapes and manipulate delicate objects. Modifying the topography of the surface of the arm improves its ability to hold soft or slippery objects.

Accordingly, the robotic arm of the invention is useful as a soft actuator that can manipulate soft and fragile objects, to operate in confined spaces, and perform complex motions.

### Controller

Motive controlling forces for the actuators may include software to cause or allow movement of the arm in a pre-determined manner. The structure and logic of the controller that will serve best to operate these structures is a computer. For example: Microcontrollers are small computers tailored to the interaction between real world sensing and real-time mechanical interactions. Pre-programmed tasks performed by the tentacle device can be modified in real-time to adapt to changing environmental and task related conditions. This is accomplished thru various sensing techniques to determine the position and performance of the device and its surroundings.

### Power Source

A power source is operative to selectively provide motive power to the apparatus as determined by the controller. By providing actuators power to change the “tension” of the plurality of control lines in a predetermined sequence the controller can produce at least one type of movement through the robotic arm substantially along the longitudinal axis.

### Mechanical and Software Tools for Robotic Positioning of the Tentacle

Mechanical and software tools effect the robotic positioning of the robotic arm and, in certain embodiments, sensors, and associated end effectors 70. Control algorithms affect control of such robotic arms and end-effectors.

In certain aspects, the invention provides an apparatus which can be controlled by an appropriate algorithm for control of the robotic arm proximally or remotely.

One aspect of the invention as illustrated in FIGS. 6 and 9 which comprises a longitudinally extending stage or multi-stage robotic arm. The arm comprises a plurality of helicoid stages each of which is articulated individually by control lines 30. The distal end of the distal stage (e.g. upper stage helicoids 90) carries a further mechanism as hereinafter described terminating in an end effector 70.

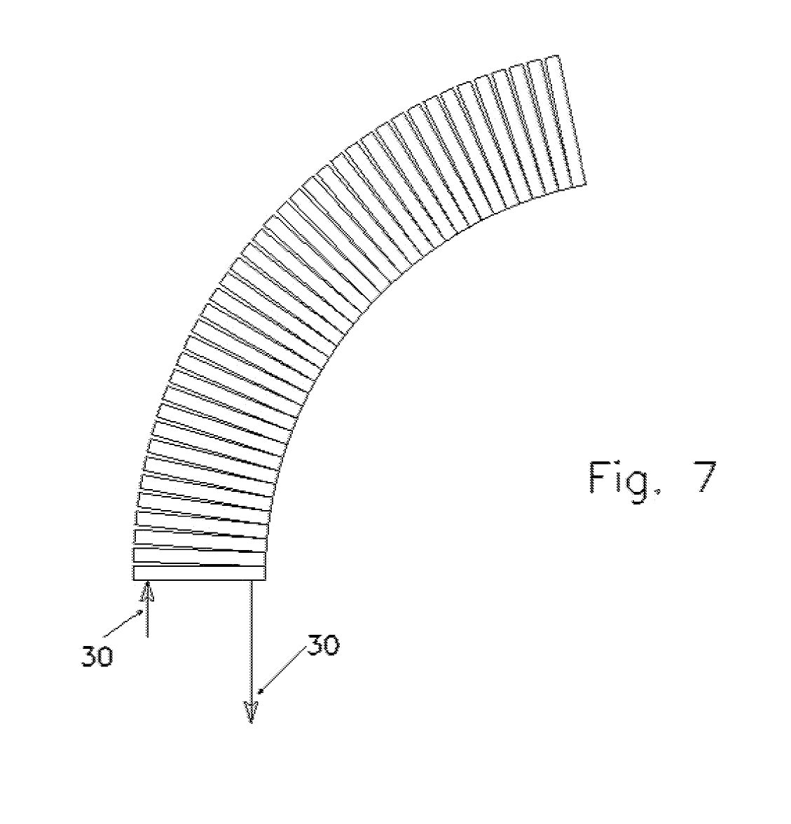

The arrangement is such that each section is capable of deflecting about an arc in at least one plane such is as illustrated in FIG. 7.

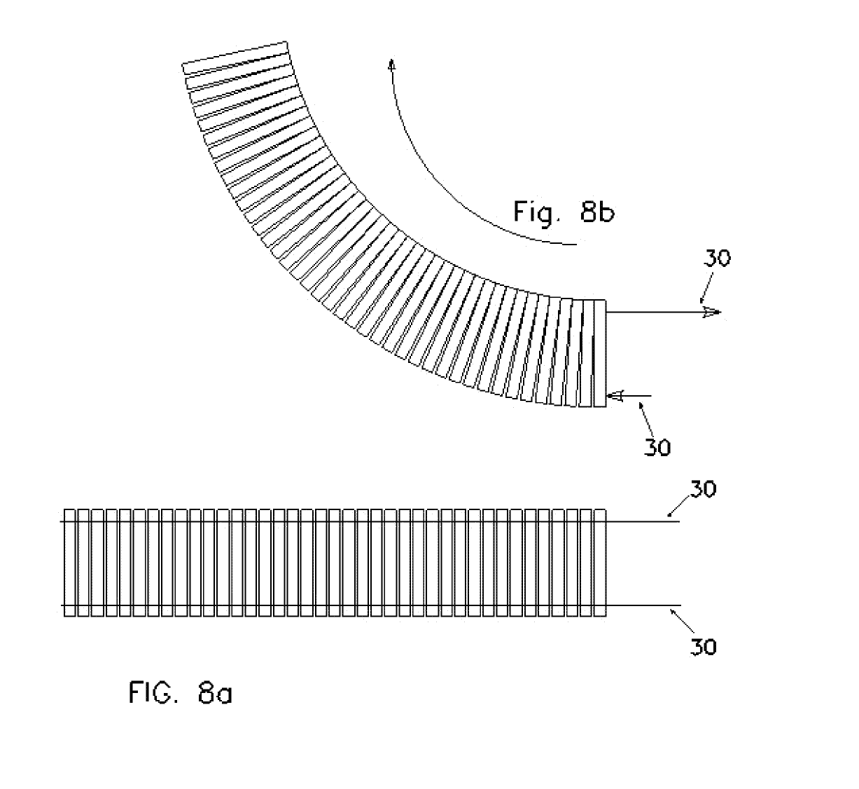

Each helicoid is connected by means of control lines to actuation control for applying tension to said control lines. In the rest position with the arm extended as shown in FIG. 8a, the control lines are maintained under equal tension. This maintains the helicoid under a degree of kinetic stability. To enable bending, the individual control lines 30 to each helicoid are subjected to increasing tension in one direction and a relaxation of tension in the opposing control line 30. Thus, as shown in FIG. 8b an increase in tension of the upper control line 30 and a corresponding relaxation of tension of the lower control line 30 would result in a flexing or bending of the segment arrangement in a upward direction.

The helicoid arm is provided with one or more CPs positioned typically disposed at small angle close to parallel with the long axis of the robotic arm. A CP may accommodate one or more control line housings, power or communication wires for controlling the array of serially connected helicoids stages and/or end-effectors associated therewith.

A central shaftway 40 provided through the center or near the center serves to provide a passageway for a spine 45, control or power supply means to an end effector 70.

It will be appreciated by the person skilled in the art that the detail of each step in the flow sheet will be dependent upon the nature of the tasks that the arm is required to perform.

From the foregoing, therefore, it will be seen that the extent to which the device can bend is almost unlimited depending, of course, upon the extent of the arm and the level of control over the individual stages or groups of stages. The motors for each stage may be carried on the stages themselves or may be provided remotely as described above.

### Plurality of Stages

Although certain embodiments of the present invention comprise a single stage continuous helicoid, other embodiments (FIGS. 6 and 9) involve numerous helicoid stages fitted in sequence to form a multistage or multi-segment robotic arm.

As in a single stage embodiment of the robotic arm, control lines are distributed around the axis. However, with multiple stages, control lines can be arranged in ranks for controlling groups of the helicoid segments at different distances from the proximal end.

Accordingly, certain embodiments of the robotic arm comprise as shown in the embodiment of FIGS. 6 and 9 a number of helicoid longitudinal stages arranged in series and each being designed as a helicoid stage. Depending on the extent of bending motions the arm shall be able to perform, each helicoid stage is provided with CPPs 25, for example, four through-bore holes placed close to the outer edge of helicoid turns and equal distance from each other and from the center of the spiral turn, said CPPs intended for an equal number of control lines disposed in each. In certain embodiments, a central shaftway 40 is arranged in the center of the helicoids turns. In an embodiment, additional CPs passing thru a tentacle stage permit one to run control cables and their housings through the most proximal, ‘bottom-most’ helicoids tentacle in a series of tentacle helicoids up to a predetermined tentacle, in which the control lines are then run through CPPs in that and/or more distal tentacle stages in order to achieve controlled movement in the stage(s) in which the control lines run through CPPs.

### End Effector—FIG. 6

As used herein, “end effector” refers to an actual working distal part that is manipulable by any means of actuation for added function, e.g., grasping, cutting, suction, congruent with an intended function of the end effector according to the purposes of the user.

For instance, some end effectors have a single working member such as a gripper or an electrode or sensor. Other end effectors have a pair or plurality of working members such as forceps, graspers, scissors, or clippers, for example.

In certain embodiments, accordingly, the helicoid tentacle defines CPs, configured as conduits for carrying control cables in communication between power source, actuator, and end effector, which may be embodied by any one of a number of alternative elements or instrumentalities associated with the operation of an end effector. A CP may contain pulling cables for an end effector.

Examples include conductors for electrically activated end effectors (e.g., electrodes; transducers, sensors, and the like); conduits for fluids, gases or solids (e.g., for suction); mechanical elements for actuating moving end-effector members (e.g., cables, flexible elements or articulated elements for operating grips, forceps, scissors); wave guides; sonic conduction elements; fiber optic elements; and the like. Such a longitudinal conduit may be provided with a liner, insulator or guide element such as an elastic polymer tube; spiral wire wound tube or the like.

The robotic arm thus may include an end effector(s) at a distal end, and is preferably servo-mechanically actuated by a system for performing functions such as holding, placing, moving or altering an object.

In certain embodiments, a CP may carry a plurality of actuation cables whose distal portions connect to the end effector.

While aspects of the present invention have been particularly shown and described with reference to the preferred embodiment above, it will be understood by those of ordinary skill in the art that various additional embodiments may be contemplated without departing from the spirit and scope of the present invention. For example, any of the described structures of the robotic arm could have any suitable dimensions, flexibilities, shapes, constructions, or other properties, and could be made of any suitable material or combination of materials. The apparatus could, for example, have a lateral width of one centimeter or less for minimally invasive procedures a lateral width of twenty-five centimeters or more for a hazardous use environment, or any other desired lateral widths or longitudinal lengths as desired for a particular use environment. Whereas the control structure and function for the apparatus are not specifically shown or disclosed herein, one of ordinary skill in the art will be able to readily provide appropriate control mechanism(s) and/or programming to control the apparatus, including the type and configuration of end-effectors and/or power source(s) provided, to achieve a desired movement of the robotic arm. A device or method incorporating any of these features should be understood to fall under the scope of the present invention as determined based upon the claims below and any equivalents thereof.

What is claimed is:

1. A tentacle mechanism comprising:
a. an elongated helicoid stage which defines a longitudinal axis of the tentacle mechanism,
b. one or more control path passageways defining through-bores formed in said helicoid stage;
c. one or more control lines disposed in said control path passageways for controlling the shape of said elongated helicoids.

2. The tentacle mechanism of claim 1 further comprising an actuator.

3. The tentacle mechanism of claim 2 further comprising a controller for controlling the actuator to cause different lengths of said mechanism to assume different or related shaped to define the desired spatial attitude of the mechanism.

4. The tentacle mechanism of claim 1 in which said control wires extend from a proximal portion of said arm to the distal portion of said arm.

5. The tentacle mechanism of claim 1 comprising an end effector coupled to the distal portion of said arm and at least one end effector actuation cable coupled to said end effector, said end effector cable element extending from said end effector through a control passageway to the proximal portion of said tentacle mechanism.
